(19) United States
(12) Patent Application Publication
(10) Pub. No.: US 2022/0072936 A1
(43) Pub. Date: Mar. 10, 2022

(54) RESIN FRAME-ATTACHED GLASS PLATE FOR VEHICLE WINDOW

(71) Applicant: AGC Inc., Tokyo (JP)

(72) Inventors: Naonori Hatta, Tokyo (JP); Kazuhiro Takahashi, Tokyo (JP)

(73) Assignee: AGC Inc., Tokyo (JP)

(21) Appl. No.: 17/468,544

(22) Filed: Sep. 7, 2021

(30) Foreign Application Priority Data
Sep. 8, 2020 (JP) 2020-150750

(51) Int. Cl. B60J 1/00; B29C 45/14

(52) U.S. Cl. CPC B60J 1/007; B29K 2709/08; B29C 45/14434

(57) ABSTRACT

A resin frame-attached glass plate for a vehicle window includes a glass plate; a resin frame attached to a peripheral edge area of the glass plate; and a decorative member disposed on the resin frame such that the resin frame is integrally molded along with the glass plate and the decorative member; wherein the resin frame has a groove formed along a boundary between the resin frame and an exposed portion of the decorative member, the groove being recessed from a surface of the resin frame.

### CROSS-REFERENCE TO RELATED APPLICATION

The entire disclosure of Japanese Patent Application No. 2020-150750 filed on Sep. 8, 2020 including specification, claims, drawings and summary is incorporated herein by reference in its entirety.

### TECHNICAL FIELD

The present invention relates to a resin frame-attached glass plate for a vehicle window.

### BACKGROUND ART

As a member for a vehicle window, there is known a structure which includes a glass plate, and a resin frame integrally attached to a peripheral edge area of the glass plate. Such a resin frame-attached glass plate is also known to further include a decorative member on a surface of the resin frame mainly for the purpose of decorating. For example, Patent Document 1 listed below discloses a structure which is manufactured by injection molding so as to include a resin frame integrally and firmly attached to a peripheral edge area of a window glass, and a decorative molding fixed to the resin frame.

### PRIOR ART DOCUMENT

### Patent Document

Patent Document 1: JP-A-2007-15555

### DISCLOSURE OF INVENTION

### Technical Problem

The structure disclosed in Patent Document 1 is obtained by placing a window glass and a decorative molding in a portion of a cavity space of a mold, and injecting a heat-melted resin in the remaining portion of the cavity space, followed by solidifying the resin to form a molded product with the window glass, the decorative molding (decorative member) and the resin frame being integrated. However, the product thus obtained is likely to have a resin burr formed at a parting position between the injected resin and the decorative member, i.e., a boundary between the decorative member and the resin on a surface of the product. Such a burr is an unnecessary portion that is unintentionally formed and can impair the appearance of the entire product. When a burr is formed, a knife or another tool is used to remove the burr in many cases. It takes much time and cost to remove such a burr because the burr is normally small and thin such that a detailed work is required for removal. Further, unnecessary damage could be inadvertently caused on the decorative member or the resin frame per se during removing work.

From this point of view, in one aspect of the present invention, it is an object of the invention to improve the appearance of a resin frame-attached glass plate with a decorative member being integrally disposed thereon for a vehicle window.

### Solution to Problem

According to the one aspect, the present invention provides a frame-attached glass plate for a vehicle window, which includes a glass plate, a resin frame attached to a peripheral edge area of the glass plate, and a decorative member disposed on the resin frame such that the resin frame is integrally molded along with the glass plate and the decorative member, wherein the resin frame has a groove formed along a boundary between the resin frame and an exposed portion of the decorative member, the groove being recessed from a surface of the resin frame.

### Advantageous Effects of Invention

According to the one aspect of the invention, it is possible to improve the appearance of a resin frame-attached glass plate for a vehicle window, wherein a decorative member is integrally disposed on the glass plate.

### BRIEF DESCRIPTION OF DRAWINGS

FIG. 1 is a plan view illustrating the resin frame-attached glass plate according to a first embodiment of the present invention.

FIG. 2 is a cross-sectional view taken along line II-II of FIG. 1.

FIG. 3 is a cross-sectional view illustrating a portion of a conventional resin frame-attached glass plate.

FIG. 4 is an enlarged partial cross-sectional view of FIG. 2, illustrating a portion of the glass plate including a groove and its surroundings.

FIG. 5 is an enlarged partial cross-sectional view of the resin frame-attached glass plate according to a modification of the first embodiment, illustrating a portion of the glass plate including the groove and its surroundings.

FIG. 6 is a cross-sectional view illustrating a portion of the resin frame-attached glass plate according to a second embodiment of the present invention.

FIG. 7 is a cross-sectional view illustrating a portion of the resin frame-attached glass plate according to a modification of the second embodiment of the present invention.

FIG. 8 is a plan view illustrating the resin frame-attached glass plate according to a third embodiment of the present invention.

FIG. 9 is a cross-sectional view taken along line IX-IX of FIG. 8.

FIG. 10 is a plan view illustrating a portion of the resin frame-attached glass plate according to a fourth embodiment of the present invention.

FIG. 11 is a cross-sectional view taken along line XI-XI of FIG. 10.

### DESCRIPTION OF EMBODIMENTS

Now, embodiments of the present invention will be described in detail in reference to the accompanying drawings. In Drawings, identical or corresponding members or elements are denoted by like references, and explanation of such members or elements will be avoided on some occasions unless otherwise specified. Drawings are schematically prepared to assist in understanding the invention. The scale of Drawings is different from actual scale on some occasion.

### First Embodiment

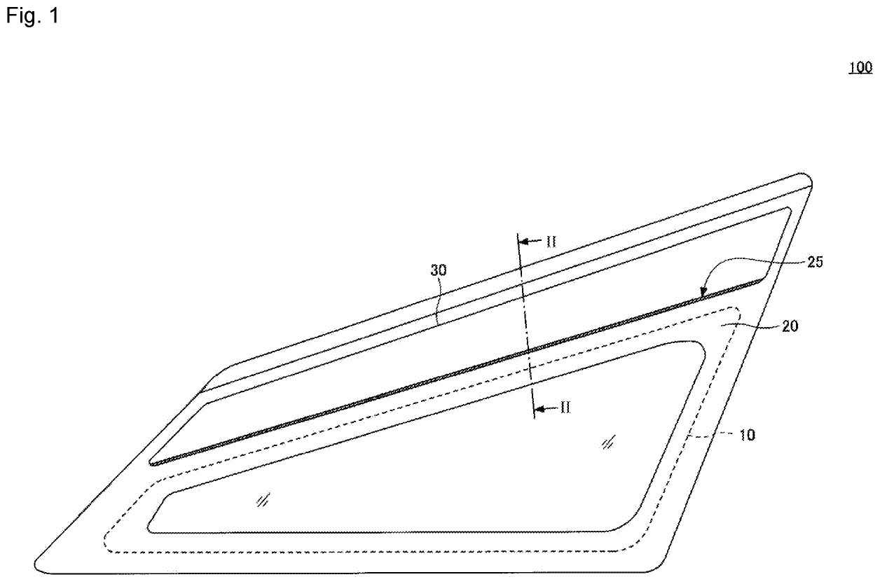

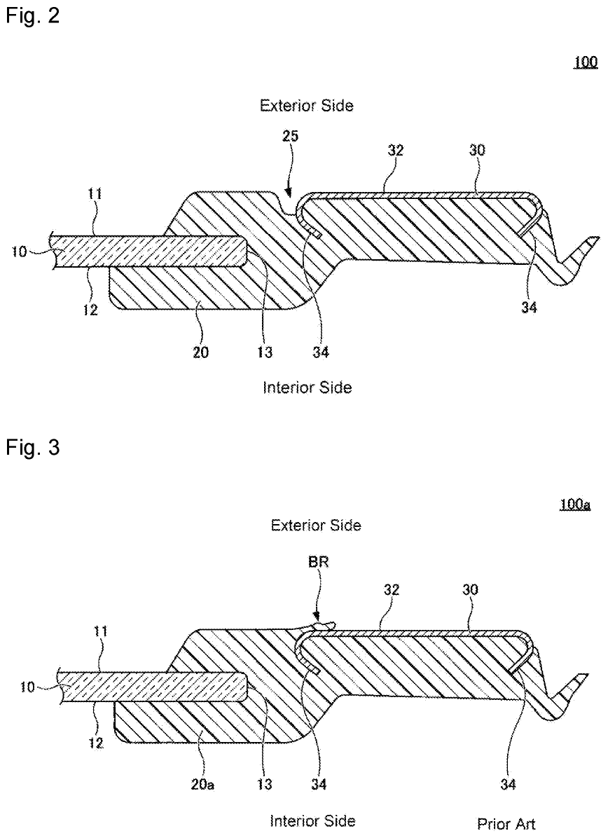

In FIG. 1, the resin frame-attached glass plate 100 according to a first embodiment of the present invention is illustrated in a plan view. FIG. 1 is a view when the resin frame-attached glass plate 100 is seen from an exterior side. In FIG. 2, a cross-sectional view taken along line II-II of FIG. 1 is illustrated. As shown in FIGS. 1 and 2, the resin frame-attached glass plate 100 is configured as a Module Assy Window (MAW) (trademark) to include a glass plate 10, and a resin frame 20 disposed on a peripheral edge area of the glass plate 10. The use of such a Module Assy Window can simplify the assembly work of a vehicle because a window glass can be mounted to a window frame of a vehicle, being accompanied with a resin frame.

The resin frame-attached glass plate 100 according to this embodiment has a decorative member (ornamental member or ornamental molding) 30 disposed on an exterior side of the resin frame 20. The glass plate according to this embodiment is a molded product wherein the glass plate 10, the resin frame 20 and the decorative member 30 are integrally molded. In Description, the term “integrated” or “integrally” means a state where the respective members cannot be disassembled during normal work for mounting the window glass to a vehicle body.

The resin frame-attached glass plate (or MAW) 100 according to this embodiment is a vehicle glass, which is applicable to a windshield, a backlite, a side lite, a roof glass, a front quarter glass, a rear quarter glass or the like. Among them, the resin frame-attached glass plate is particularly applicable to a front quarter glass or a rear quarter glass.

It is sufficient that the glass plate 10 used in the resin frame-attached glass plate 100 according to this embodiment is a glass plate for a vehicle window. The glass plate is not limited to a special one. The glass used in the glass plate 10 may be made of inorganic glass, specifically, soda-lime silicate glass, aluminosilicate glass, borate glass, lithium aluminosilicate glass, borosilicate glass or the like. Although there is no particular limitation to the method for forming the glass plate, a glass plate that is formed by a float process or the like is preferable for example. The glass plate 10 may be made of either non-tempered glass, glass tempered by air quenching, or chemically tempered glass. Non-tempered glass is prepared by forming molten glass in a plate shape and annealing the formed glass. The tempered glass is prepared by producing a compressive stress layer in the surface of non-tempered glass. The tempered glass may be either physically tempered glass (such as glass tempered by air quenching) or chemically tempered glass. When the glass plate is made of glass tempered by air quenching, the glass plate may have a glass surface tempered by uniformly heating the glass plate and quenching the heated glass plate from a temperature close to its softening point to produce compressive stress in the glass surface by its temperature difference between the glass surface and the inside of the glass plate. When the glass plate is made of chemically tempered glass, the glass plate may have a glass surface tempered by producing compressive stress in the glass surface by ion exchange or the like.

The glass plate 10 may be a glass plate that absorbs ultraviolet rays or infrared rays. The glass plate is preferably transparent, but may be made of glass that is colored so as not to impair transparency. The glass plate 10 may have one or both of principal surfaces coated with a coating layer, which achieves an ultraviolet ray shielding function, an infrared ray shielding function, a defogging function, or another function.

The glass plate 10 may have an optically shielding layer (also called dark ceramic layer) disposed on a peripheral edge area so as to extend along an interior side surface. The optically shielding layer achieves the function of protecting a sealant etc. for bonding the glass plate for a vehicle to a vehicle body and holding the glass plate to the vehicle body. The optically shielding layer may be disposed by being baked after application of colored ceramic paste (glass paste) to a surface of the glass plate.

The glass plate 10 may be formed in a square shape having different apex angles shown in FIG. 1 or a rectangular shape as seen in a plan view. The glass plate 10 may be formed in a shape other than square shapes, such as a triangular shape. The glass plate may have a thickness of 0.2 to 5 mm, preferably 0.3 to 2.4 mm.

The glass plate 10 according to this embodiment may be made of laminated glass, wherein plural glass plates made of any one of the above-mentioned glass are laminated. The laminated glass may be configured to have plural glass plates made of any one of the above-mentioned glass bonded together through an interlayer containing a thermoplastic resin. When the glass plate 10 is made of laminated glass, the glass plate positioned on an exterior side has a thickness of preferably 1.1 mm to 3 mm in its thinnest portion. When the glass plate positioned on the exterior side has a thickness of at least 1.1 mm, the glass plate has a sufficient strength, such as a resistance to a hitting stone. When the glass plate positioned on the exterior side has a thickness of at most 3 mm, the laminated glass can avoid having an excessively large weight, which is preferable in terms of fuel consumption of the vehicle. The glass plate positioned on the exterior side has a thickness of more preferably 1.6 to 2.8 mm, much more preferably 1.6 to 2.6 mm, furthermore preferably 1.6 to 2.3 mm, most preferably 1.6 to 2.0 mm in its thinnest portion. The glass plate positioned on an interior side has a thickness of preferably 0.3 to 2.3 mm. When the glass plate positioned on the interior side has a thickness of at least 0.3 mm, it is easy to handle the glass plate. When the glass plate positioned on the interior side has a thickness of at most 2.3 mm, the laminated glass can avoid having an excessively large weight.

The glass plate 10 may be formed in a single curved shape to be bent in a single direction, or in a complex curved shape to be bent in two directions (for example, a certain direction and a direction perpendicular to the certain direction). Examples of the bending operation include gravity bending and press bending. When the glass plate 10 is curved, being bent with a certain curvature, the glass plate may have a radius of curvature of 1,000 to 100,000 mm.

As shown in FIGS. 1 and 2, the resin frame 20 is disposed on the peripheral edge area of the glass plate 10. The resin frame 20 may be disposed on the entire peripheral edge area of the glass plate 10 so as to be continuous in a peripheral direction as shown in FIG. 1, or disposed partly on the peripheral edge area of the glass plate 10 so as to be discontinuous in the peripheral direction. It is sufficient that the resin frame 20 is disposed so as to be brought into contact with an end surface 13 of the glass plate 10, and at least one of principal surfaces (interior surface and/or exterior surface of the principal surfaces). More specifically, the resin frame 20 may be disposed so as to cover a total of three surfaces of the end surface 13 of the glass plate 10, and the exterior surface 11 and the interior surface 12 at the peripheral edge area of the glass plate as shown in FIG. 2, or may be disposed so as to cover two surfaces of the end surface 13 of the glass plate 10 and the interior surface 12 at the peripheral edge area without covering the exterior surface 11 (which will be described later). When the resin frame 20 is disposed so as to cover the three surfaces at the peripheral edge area of the glass plate 10 as shown in FIG. 2, the glass plate 10 is held from three directions at the peripheral edge area to be stably positioned with respect to the resin frame 20, resulting in an increase in the strength of the resin frame-attached glass plate 100. The range where the resin frame 20 is disposed on the principal surfaces of the glass plate 10 may be at least 3.0 mm away from an end edge of the glass plate 10 (or the end surface 13) on the exterior surface 11 and at least 3.0 mm away from the end edge of the glass plate on the interior surface 12.

There is no particular limitation to the resin to be used in the resin frame 20 so long as it is possible to produce a product with the resin frame being internally molded along with the glass plate 10 and the decorative member 30. The resin is preferably a material usable in injection molding, i.e., a material that is heat-meltable and solidifiable by cooling performed after heating. The resin to be used in the resin frame 20 may be a thermoplastic resin. Examples of the thermoplastic resin include a polyvinylchloride resin, or a polyolefin-based, polyester-based, polystyrene-based, polyamide-based or polyurethane-based resin.

The decorative member 30 may be an elongated plate-shaped exterior member, which is disposed on the exterior side of the resin frame-attached glass plate 100 mainly for the purpose of decorating a vehicle window. The decorative member 30 may have a thickness of preferably 0.1 to 0.7 mm, more preferably 0.4 to 0.5 mm. The decorative member 30 may have an oxidized coating or a film disposed on a surface thereof (exterior side surface) to protect the surface.

The decorative member 30 may be disposed on the resin frame 20 in a range where the resin frame 20 is disposed as seen in plan view. Although the decorative member 30 is disposed along one side of the resin frame-attached glass plate 100 as an integrally molded product formed in a substantially square shape as seen in plan view in the mode shown in FIG. 1, the decorative member may be disposed along at least two sides of the resin frame-attached glass plate 100, or may be continuously disposed along the entire peripheral edge of the resin frame-attached glass plate.

The decorative member 30 includes an exposed portion 32 exposed from the resin frame 20, and first and second embedded portions 34 embedded in the resin frame 20. The exposed portion 32 of the decorative member 30 extends substantially in parallel with a planar direction of the glass plate 10 while the embedded portions are embedded inside the resin frame 20, being bent toward the opposite side of an exposed surface of the exposed portion 32. In the mode shown in FIG. 2, the first and second embedded portions 34 are disposed on a side closer to and a side farther from the glass plate 10 in a width direction of the decorative member 30, respectively.

The decorative member 30 may be made of a rigid material, such as a metal or a rigid resin. The decorative member is made of preferably a metal, in particular stainless steel, in terms of high rigidity and ease in imparting gloss. The stainless steel may be austenitic stainless steel or ferritic stainless steel. Specific examples include NK-430MA, NK-436L-NB, SUS430, and SUS304. The use of the decorative member 30 made of a metal not only can provide the resin frame-attached glass plate 100 with a sophisticated impression having an excellent design but also reinforce the resin frame 20 along the peripheral edge.

The resin frame-attached glass plate 100 according to this embodiment may be formed by injection molding. More specially, the resin frame-attached glass plate may be formed by placing the glass plate 10 and the decorative member 30 at certain positions in the cavity of a mold, followed by press-injecting a heat-melted resin in the cavity, cooling the resin for solidification, and removing the mold. In such injection molding, it is likely that a burr is formed at a parting position between the injected resin and the decorative member (boundary between the decorative member and the resin on a surface of the resin frame-attached glass plate). Such a burr is a residual portion or unnecessary portion of a product produced by molding, and has an irregular shape (in terms of thickness or profile). When such a burr remains on the product and is visible, the appearance of the product is impaired. For example, a conventional resin frame-attached glass plate for a vehicle 100a has a burr BR formed between a resin frame 20a and a decorative member 30 (see FIG. 3). When the conventional resin frame-attached glass plate for a vehicle is seen from outside, it is visually recognized that the burr BR adheres to a surface of the decorative member 30, which impairs the appearance of the decorative member 30.

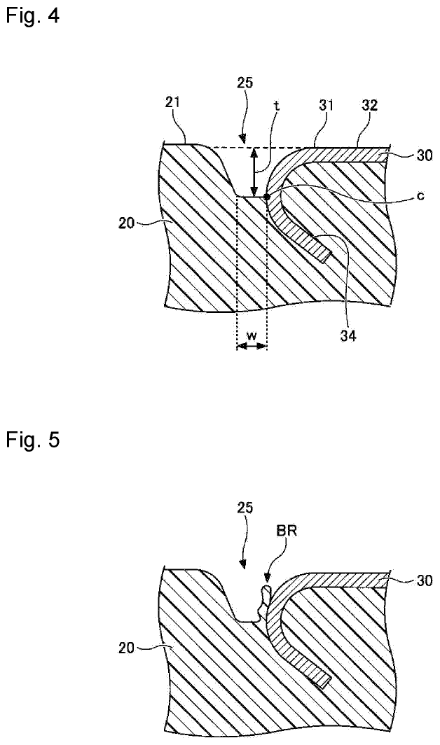

In contrast, in this embodiment, the resin frame 20 has a groove 25 formed therein at a parting position between the resin frame 20 and the decorative member 30, i.e., along a boundary between the resin frame 20 and the exposed portion 32 of the decorative member 30 as shown in FIGS. 1 and 2. In FIG. 4, the groove 25 in the resin frame-attached glass plate 100 and surroundings of the groove shown in FIG. 2 are shown as an enlarged partial cross-sectional view. As shown in FIG. 4, the groove 25 is formed by a portion recessed from the surface (exterior surface) of the resin frame 20 toward a thickness direction of the resin frame, and has a certain depth t and a certain width w. In other words, the position of the boundary between the exposed portion 32 of the decorative member 30 and the first embedded portion 34 is displaced toward the center of the thickness direction, or an extended portion is added to the exposed portion 32 of the decorative member 30 to extend toward the thickness direction. By this arrangement, the boundary between the exposed portion 32 and the first embedded portion 34 is made unnoticeable when seen from the exterior side.

By this arrangement, even when a resin burr is formed, the burr BR is formed, for example, at a position close to the bottom of the groove as schematically shown in FIG. 5. Even when the resin frame-attached glass plate is seen from the exterior side, the burr is difficult to be seen. In particular, when the decorative member 30 or the resin frame 20 is shadowed at the groove 25, depending on illumination, the inside of the groove 25 is difficult to be seen or is made invisible such that even when a burr is formed, the burr is further difficult to be seen or is further made invisible.

When a burr is formed, the formed burr can be removed by a knife or the like. When an attempt is made to use a knife or the like in order to remove the formed burr in a burr removing step, unnecessary damage could be inadvertently caused on the decorative member 30 or the resin frame 20. The formation of such damage is preferably avoided, in particular when the decorative member 30 has an oxidized coating or a film disposed thereon. In accordance with this embodiment, a formed burr is difficult to be seen or is made invisible, which allows the omission of the burr removing step, and reduces or avoid the likelihood that a product is damaged. By this embodiment, even a resin frame-attached glass plate that is not subjected to a burr removing treatment is made acceptable as a final product. The resin frame-attached glass plate 100 according to this embodiment is excellent in appearance and can be provided at a lower price because of reducing the cost and time that have been conventionally required for removing a burr.

For example, when a comparatively large burr is formed, the burr must be removed in some cases. Such removing work could damage the product. Even in such a case, the position where the product is damaged is present in the groove 25, which makes the damage unnoticeable or difficult to be noticeable. Thus, this embodiment allows the resin frame-attached glass plate 100 to have an excellent appearance irrespectively whether the glass plate is subjected to a burr removing step or not.

The groove 25 may have a depth t (see FIG. 4) of preferably 0.5 to 2.0 mm, more preferably 0.8 to 1.5 mm. When the depth t of the groove 25 is set to at least 0.5 mm, it is possible to improve the effect for making a burr unnoticeable. Even when the resin frame 20 or the decorative member 30 is damaged by removing a burr , it is possible to improve the effect for making the damage unnoticeable. On the other hand, when the depth t of the groove is set to at most 2.0 mm, it is possible to ensure that the frame-attached glass plate 100 has a sufficient strength. The depth t of the groove formed in the resin frame 20 may be determined to be a length from a lower one of a top surface 21 of the resin frame 20 and a top surface 31 of the decorative member 30 to a bottom surface of the groove 25 (contact position c between the resin frame 20 and the decorative member 30 in the groove 25 when the bottom surface is not flat) as seen in section taken along the thickness direction. In a case shown as a cross-sectional view in FIG. 4, the depth t may be measured from either the top surface 21 of the resin frame 20 or the top surface 31 of the decorative member 30 because the top surface 21 of the resin frame 20 and the top surface 31 of the decorative member 30 are positioned at the same level.

The groove 25 may have a width w (see FIG. 4) of preferably 0.5 to 3.0 mm, more preferably 0.8 to 2.0 mm. When the width w of the groove 25 is set to at least 0.5 mm, it becomes easy to design a ridge formed in a side wall of a mold. When the width w is set to at most 3.0 mm, it is possible not only to reduce the adverse effect to appearance by the groove 25 per se but also to ensure the strength of the resin frame-attached glass plate 100. The width w is the width of the bottom surface of the groove 25. When the bottom surface is not flat, or not in parallel with the planar direction of the resin frame-attached glass plate 100 (glass plate 10), the width may be determined to be the width at the level of the contact position c between the resin frame 20 and the decorative member 30 in the groove.

The depth t of the groove 25 may vary depending on positions. The width w of the groove may also vary depending on positions. The depth t and/or the width w of the groove may be designed, in consideration of the ease in the formation of a burr, depending on, for example, the structure of a mold used for molding the resin frame-attached glass plate 100 (the size, the shape, the sprue position etc. of the mold), the size and the shape of the decorative member 30, and the property of a used resin.

In the embodiment shown in FIGS. 1 and 2, the groove that is formed in the resin frame 20 so as to be recessed from the surface of the resin frame 20 is formed at a position close to the first embedded portion 34 of the decorative member 30 closer to the glass plate 10. Even when the groove is formed at a position close to the other embedded portion 34 of the decorative member 30, i.e., the second embedded portion 34 farther from the glass plate 10, a similar effect is obtained.

As described above, the decorative member 30 may be an elongated member extending along a peripheral edge of the glass plate 10 as shown in FIG. 1. The groove 25 formed in the resin frame 20 extends along the decorative member 30. The groove 25 may be continuously or discontinuously formed along the decorative member 30. The groove may be formed over the entire length of the decorative member 30 or only in a part of the length of the decorative member. The upper limit of the continuously extending portion of the groove 25 may be determined by the length of the decorative member 30. The continuously extending portion of the groove 25 has a length of preferably at least 3.0 mm because it is possible to obtain a sufficient effect that even when a burr is formed in the groove 25, the burr is difficult to be seen, or the inside of the groove 25 is difficult to be seen.

### Second Embodiment

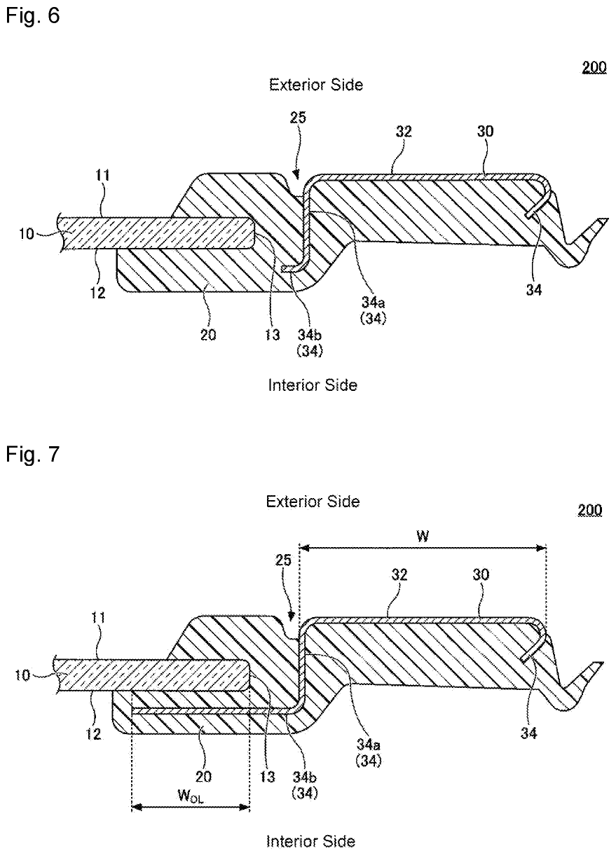

FIGS. 6 and 7 illustrate the resin frame-attached glass plate 200 according to a second embodiment of the present invention. FIGS. 6 and 7 are cross-sectional views taken along the thickness direction of the resin frame-attached glass plate and correspond to FIG. 2 illustrating the first embodiment.

As shown in FIG. 6, the resin frame-attached glass plate 200 is the same as the resin frame-attached glass plate 100 (see FIG. 2) in terms of basic structure, but is different from the resin frame-attached glass plate 100 (see FIG. 2) in that the decorative member 30 includes a reinforcing means. The reinforcing means is one to prevent the resin frame 20 (or the resin frame 20 and the decorative member 30) from shifting with respect to the glass plate 10 or detached from the glass plate 10 when a force is applied to a portion of the resin frame 20 where the exposed portion 32 of the decorative member 30 is positioned. In the case shown in FIG. 6, the reinforcing means is given by the structure of the first embedded portion 34 closer to the glass plate 10. More specifically, the first embedded portion 34 enters deeply in the thickness direction of the resin frame 20 to form the reinforcing means. As shown in FIG. 6, the first embedded portion 34 closer to the glass plate 10 is preferably configured to extend in a range covering the glass plate 10 in the thickness direction of the resin frame 20.

As shown in FIG. 6, the first embedded portion 34 further preferably includes a thickness direction section 34a extending substantially in the thickness direction and a principal surface direction section 34b extending from a leading edge of the thickness direction section 34a toward substantially the principal surface direction. The first embedded portion 34 can include the thickness direction section 34a and the principal surface direction section 34b extending from the thickness direction section 34a so as to be bent or curved, resulting in further improvement of the reinforcing function.

As shown in FIG. 6, the principal surface direction section 34b preferably extends beyond the groove 25 as seen in plan view. When a force is applied to the decorative member 30 or the resin frame 20, the resin frame 20 tends to be easily bent around the groove 25. When the principal surface direction section 34b is configured to extend beyond the groove 25, i.e., extend across the groove 25 as seen in plan view, the first embedded portion 34 has an improved reinforcing function against bending.

FIG. 7 illustrates a modification of the resin frame-attached glass plate 200 shown in FIG. 6. The modification shown in FIG. 7 is the same as the case shown in FIG. 6 in terms of basic structure, but is different from the latter in that the first embedded portion 34 having the reinforcing function has the principal surface direction section 34b further extending. In FIG. 7 the principal surface direction section 34b is beyond the groove 25 so as to extend so as to overlap with the glass plate 10 as seen in plan view. By this arrangement, it is possible to further improve the reinforcing function against bending such that the resin frame-attached glass plate 200 has a further improved strength.

When the principal surface direction section 34b overlaps with the glass plate 10 as seen in plan view as shown in FIG. 7, the distance W_{OL} from an end edge (the position of the end surface) of the glass plate 10 to a leading edge of the principal surface direction section 34b (a leading edge of the first embedded portion 34) is preferably 3.0 to 10.0 mm.

In the resin frame-attached glass plate 200 shown in FIGS. 6 and 7, the reinforcing function given by the principal surface direction section 34b of the first embedded portion 34, i.e., the extending range (extending length) of the first embedded portion 34 may be properly determined according to the size and the shape of the decorative member 30, the material forming the resin frame 20, the material and the thickness of the glass plate 10, or another factor. In particular, when the exposed portion 32 of the decorative member 30 has a large width W, the extending range of the principal surface direction section 34b is preferably increased to improve the reinforcing function because the decorative member 30 is likely to be bent when a force is applied to the decorative member 30. The width of the exposed portion 32 may be 10 to 30 mm, and may be as wide as 10 to 150 mm in order to have an improved designability on appearance in some cases. When the distance W_{OL} to the leading edge of the principal surface direction section 34b (the leading edge of the first embedded portion 34) is set to at least 3.0 mm, it is possible to sufficiently improve the reinforcing function. The distance W_{OL} in the extending range is preferable in particular when the exposed portion 32 is wide as described above.

Although the thickness direction section 34a of the first embedded portion 34 extends along the thickness direction in each of the cases shown in FIGS. 6 and 7, the thickness direction section may be angled with respect to the thickness direction, in other words, be slant so as to be gradually closer to the glass plate 10 toward the interior side.

### Third Embodiment

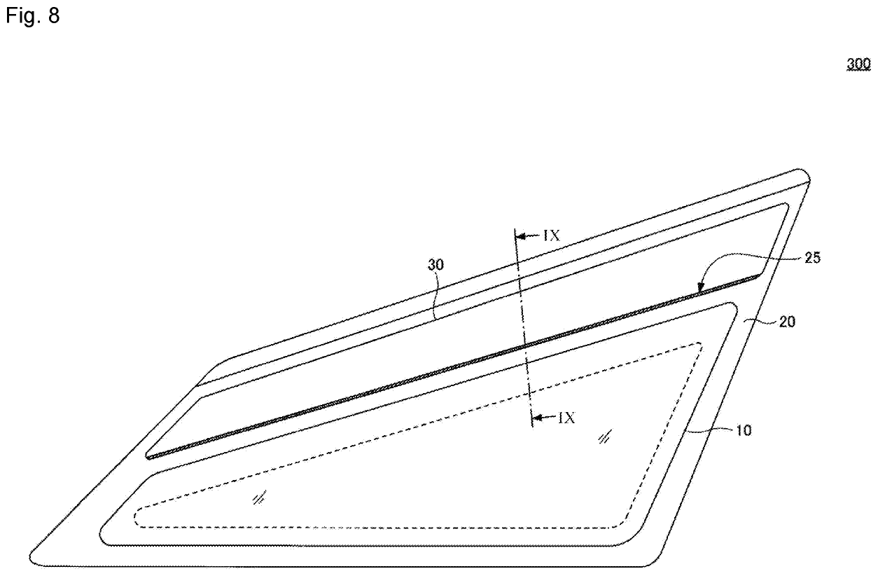

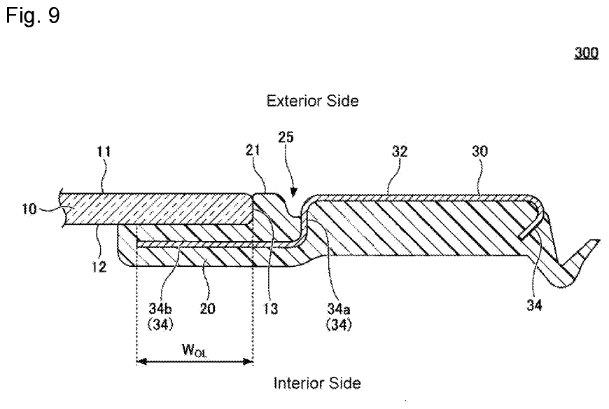

FIG. 8 illustrates the resin frame-attached glass plate 300 according to a third embodiment of the present invention as seen from the exterior side. FIG. 9 illustrates a cross-sectional view taken along line IX-IX of FIG. 8. The resin frame-attached glass plate 300 has the same as the resin frame-attached glass plate 200 shown in FIG. 7 in terms of basic structure, but is different from the case shown in FIG. 7 in terms of the arrangement of the resin frame 20.

In the resin frame-attached glass plate 300, the resin frame 20 is not substantially disposed or not disposed on the exterior side 11 of the glass plate 10 as shown in FIGS. 8 and 9. In Description, the term “not substantially disposed” means that it is acceptable that a resin portion is unintentionally disposed on the exterior side of the glass plate during resin molding. In other words, a burr may be formed on the exterior side 11 of the glass plate 10 in this embodiment.

In this embodiment, the resin frame 20 is disposed so as to be brought into contact only with the end surface 13 and the interior side 12 of the glass plate 10 (only two surfaces) as described above. This arrangement provides a structure where the exterior side 11 of the glass plate 10 is fully exposed, more specifically, the glass plate 10 has a peripheral edge area exposed. Thus, the entire glass plate 10 looks large, having a design exhibiting an open feeling.

When the resin frame 20 is not disposed on the exterior side 11 of the glass plate 10 as in this embodiment, the glass plate can have an improved designability on appearance, but has strength slightly reduced in comparison with the structure where the resin frame 20 is disposed on three surfaces of the glass plate 10 (as shown in FIGS. 2, 6 and 7). From this point of view, it is preferable that the decorative member 30 include a reinforcing means as shown in FIG. 9, i.e., that the first embedded portion 34 includes the principal surface direction section 34b. The principal surface direction section 34b is further preferably disposed to overlap with the glass plate 10 as seen in plan view. In this embodiment wherein the resin frame 20 is not substantially disposed on the exterior side 11, the principal surface direction section 34b has a distance W_{OL} to its leading edge (leading edge of the first embedded portion 34), which is preferably at least 3.0 mm.

The glass plate 10 may have an end edge chamfered or unchamfered. When the glass plate has an end edge chamfered, it is acceptable in this embodiment that the resin frame 20 is disposed or not disposed on the chamfered end edge.

The exterior side 11 of the glass plate 10 may be the same level as the top surface 21 of the resin frame 20 or different from the latter. The exterior side 11 of the glass plate 10 is preferably flush with the top surface 21 of the resin frame 20 as shown in FIG. 9. When the glass plate 10 is flush with the resin frame 20, the resin frame-attached glass plate can have an appearance having a simple and sophisticated impression. When the top surface 21 of the resin frame 20 is also flush with the top surface 31 of the decorative member 30, the resin frame-attached glass plate can have an appearance having an improved designability.

### Fourth Embodiment

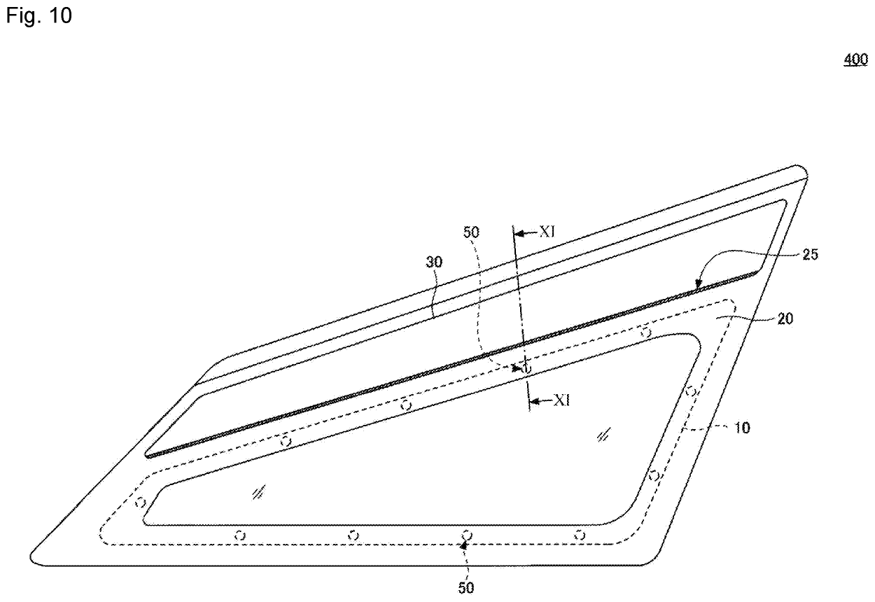

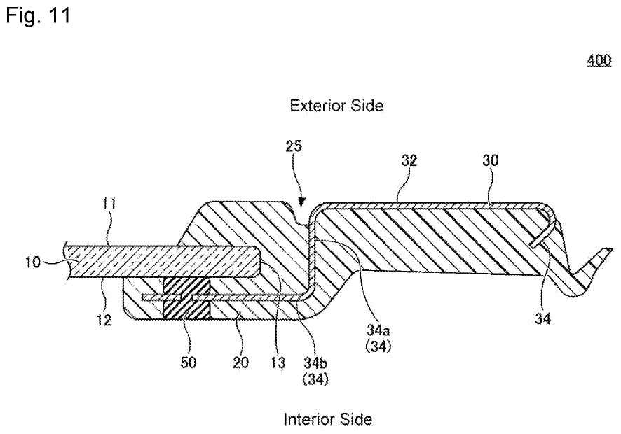

FIG. 10 illustrates a plan view of the resin frame-attached glass plate 400 according to a fourth embodiment of the present invention as viewed from the exterior side. FIG. 11 illustrates a cross-sectional view taken along line XI-XI of FIG. 10. The resin frame-attached glass plate 400 has the same as the resin frame-attached glass plate 200 shown in FIG. 7 in terms of basic structure, but is different from the case shown in FIG. 7 in that the resin frame 20 has an insert 50 embedded therein.

The insert 50 is made of a different material from the resin frame 20 and may be disposed at least between the interior side 12 of the glass plate 10 and the principal surface direction section 34b of the first embedded portion 34 of the decorative member 30 in the resin frame 20. The insert 50 may extend from the interior side 12 of the glass plate 10 toward the thickness direction and be exposed at the interior side of the resin frame 20 as in this case shown in FIG. 10.

Although there is no particular limitation to the shape of the insert 50, the insert may be formed in a dumbbell shape as shown in FIG. 11. In the shown case, the insert 50 has a central portion in the dumbbell shape fit in a hole formed in the principal surface direction section 34b, and one of enlarged diameter portions of the dumbbell shape is disposed between the glass plate 10 and the principal surface direction section 34b while the other enlarged diameter portion is disposed at the interior side of the principal surface direction section 34b so as to be exposed from the resin frame 20. The exposed surface of the insert 50 is preferably flush with the interior side of the resin frame 20.

The insert 50 is preferably made of an elastic material, for example, rubber, such as ethylene-propylene-diene rubber (EPDM) or urethane. This arrangement can provide the resin frame 20 with elasticity since the insert 50 is disposed in the resin frame.

The insert 50 may be disposed before injection of the resin during the production of the resin frame-attached glass plate 400. Thus, the principal surface direction section 34b of the decorative member 30 can be held at a proper position during injection of the resin. In other words, the insert 50 can support the principal surface direction section 34b in the thickness direction, maintaining a proper distance between the glass plate 10 and the principal surface direction section 34b of the decorative member 30.

The insert 50 may be disposed at plural positions along a longitudinal direction of the decorative member 30 as seen in plan view (see FIG. 10). When there are plural inserts 50, the inserts may be disposed at a pitch of preferably 30 to 100 mm, more preferably 40 to 60 mm as seen in plan view.

In all of the above-mentioned embodiments (the first to fourth embodiments), each of the resin frame-attached glass plates 100, 200, 300 and 400 may have a primer disposed between the glass plate 10 and the resin frame 20. For example, a primer may be applied to at least a portion of the glass plate 10 to dispose a resin thereon, followed by injection-molding the resin, during production. The presence of the primer can improve the adhesiveness between the glass plate 10 and the resin frame 20, consequently increasing the strength of each of the resin frame-attached glass plates 100, 200, 300 and 400. The primer may be properly selected according to the kind of glass used in the glass plate 10 and/or the kind of the resin used in the resin frame 20.

In order to improve the bonding strength between the resin frame 20 and the decorative member 30, a mechanical lock may be formed therebetween. The mechanical lock may be, for example, configured such that the decorative member 30 has a recess, a through hole or a projection formed on a surface thereof, and a projection formed on the resin frame 20 in touch with the surface of the decorative member is fit in the recess or the through hole formed in the decorative member 30, or the projection formed on the decorative member 30 is fit in a recess formed in the resin frame 20.

What is claimed is:

1. A resin frame-attached glass plate for a vehicle window, comprising:
a glass plate;
a resin frame attached to a peripheral edge area of the glass plate; and
a decorative member disposed on the resin frame such that the resin frame is integrally molded along with the glass plate and the decorative member;
wherein the resin frame has a groove formed along a boundary between the resin frame and an exposed portion of the decorative member, the groove being recessed from a surface of the resin frame.

2. The resin frame-attached glass plate according to claim 1, wherein the groove has a depth of 0.5 to 2.0 mm.

3. The resin frame-attached glass plate according to claim 1, wherein the groove has a width of 0.5 to 3.0 mm.

4. The resin frame-attached glass plate according to claim 1, wherein the decorative member has an embedded portion embedded in the resin frame; and
the embedded portion extends in a range covering the glass plate in a thickness direction of the glass plate.

5. The resin frame-attached glass plate according to claim 4, wherein the embedded portion overlaps with the groove as seen in plan view.

6. The resin frame-attached glass plate according to claim 5, wherein the embedded portion overlaps with the glass plate as seen in plan view.

7. The resin frame-attached glass plate according to claim 6, wherein the decorative member is elongated; and
the exposed portion has a width of 10 to 150 mm.

8. The resin frame-attached glass plate according to claim 1, wherein the glass plate has no resin frame disposed on an exterior side.

9. The resin frame-attached glass plate according to claim 8, wherein the glass plate is flush with the resin frame on the exterior side.

10. The resin frame-attached glass plate according to claim 6, wherein an insert is disposed between the glass plate and the embedded portion so as to extend in the thickness direction.
